(19) United States
(12) Patent Application Publication
(10) Pub. No.: US 2026/0202509 A1
(43) Pub. Date: Jul. 16, 2026

(54) QUANTUM RADAR SYSTEM BASED ON NYTROGEN-VACANCY-CENTERS

(71) Applicant: Pierre Gandolfo, Le Cannet (FR)

(72) Inventor: Pierre Gandolfo, Le Cannet (FR)

(21) Appl. No.: 19/238,867

(22) Filed: Jun. 16, 2025

Related U.S. Application Data
(60) Provisional application No. 63/744,922, filed on Jan. 14, 2025.

(51) Int. Cl. G01S 7/03

(52) U.S. Cl. CPC G01S 7/032

(57) ABSTRACT

Embodiments of the present disclosure provide to a quantum radar apparatus based on NV-centers where, by default, each electromagnetic sensing element is built around one or alternatively two Field Effect Transistor (FET) on silicon over insulator, placed across a drain-source channel, and having their corner front-gate facing a NV-based nanostructure.

### CROSS-REFERENCE TO RELATED APPLICATIONS

The present document claims the benefits (i.e. provisional application for patent) of the earlier filing date of patent application #U.S. 63/744,922 (confirmation number 4343) filled on Jan. 14, 2025, and entitled “Quantum Radar System based on Nitrogen-Vacancy-Centers”; the contents of which are incorporated by reference.

### STATEMENT REGARDING FEDERALLY SPONSORED RESEARCH OR DEVELOPMENT

Non-applicable

### REFERENCE TO SEQUENCE LISTING, A TABLE, OR A COMPUTER PROGRAM LISTING COMPACT DISC APPENDIX

Non-applicable.

### BACKGROUND OF THE INVENTION

The present invention relates to radar (RAdio Detection And Ranging) systems that use electromagnetic waves to detect the presence, position and speed of a target (inc. object, people and beyond).

In a radar system, the waves sent by the transmitter are reflected by the target(s), and the return signals (called radar echoes) are picked up and analyzed by the receiver, often located in the same location as the transmitter. Distance is calculated through round-trip delay of the signal, the azimuthal/elevation angular position is calculated through the antenna elements phase shift and spatial frequency, and the speed is calculated from the Doppler frequency shift, thus providing a complete 4-Dimension target detection (3D space+time).

Quantum radars are extremely-sensitive radars which boost the detection efficiency of weakly reflecting targets in environments with low signal power and strong background noise.

But the problem with existing quantum radars, such as silicon-based spin qubit, described in patent #U.S. Pat. No. 11,894,475 B2, is that they best operate at cryo-temperature instead of room temperature which results in a cumbersome cooling setup and limited portability.

The hereby-prop quantum radar system based on Nitrogen-Vacancy (NV)-centers proposes to remove all the aforementioned limitations by enabling a complete and extremely-sensitive 4-Dimension target detection (3D space+time) while operating at room temperature for maximum portability.

### BRIEF SUMMARY OF THE INVENTION

Consistent with the title of this section, only a brief description of selected features of the present invention is now presented. A more complete description of the present invention is the subject of this entire document.

The quantum radar system based on NV-centers according to the invention enable to suppress all aforementioned drawbacks. A feature of the quantum radar system based on NV-centers according to the invention is that it is made of multiple electromagnetic sensing elements (aka range bins), each built around a single FET (Field Effect Transistor) on silicon over insulator placed across a drain-source channel, with a Field-Generation (FG) corner front-gate and a Back-Gate (BG), facing a NV-based nanostructure.

Another feature of the quantum radar system based on NV-centers according to the invention is that the magnitude of the electrical field, from the target-reflected electromagnetic signal and for a given range bin, reacts with the underlying quantum dot velocity to produce a magnetic field that will be measured by the facing NV-based nanostructure.

In another embodiment of the present invention, each range bin is built instead around two FET (Field Effect Transistor) on silicon over insulator, placed across a drain-source channel, with Field-Generation (FG) corner gates facing one another. A NV-based nanostructure placed within the inter-space of the two-corner front-gates then directly measures the magnitude of the electrical field from the target-reflect electro magnetic signal and for a given range bin.

Another feature of the quantum radar system based on NV-centers according to the invention is that it is highly-scalable, and at silicon-level, over multiple range bins by for instance implementing a series of Field-Generation (FG) gates in parallel along a Drain-Source channel and having them connected to the same or different antenna elements via filters and amplifiers. Such configuration allowing then the calculation of distance with very fine resolution over fast time, of speed through Doppler phase changes over slow time, and of azimuthal/elevation arrival angle through antenna phase shift and spatial frequency, thus leading to a complete 4-Dimension target detection with high precision.

As such, the quantum radar system based on NV-centers according to the invention is particularly well-suited for any type of extremely-sensitive and portable radar applications but also complementary usage such as tomography/MRI (Magnetic Resonance Imaging).

### BRIEF DESCRIPTION OF THE SEVERAL VIEWS OF THE DRAWING

A more complete appreciation of the present invention and many of the attendant advantages thereof will be readily obtained as the same becomes better understood by reference to the following detailed description when considered in connection with the accompanying drawings. In these drawings like reference numerals designate identical or corresponding parts throughout the several views.

FIG. 1a shows, in a three-dimensional space, an embodiment of the quantum radar system based on NV-centers according to the invention with multiple range bins, each built through a FET corner front-gate and back-gate facing a NV-based nanostructure along a Drain-Source channel, and having such corner gates connected to the same antenna via filters, amplifiers and optional mixer; FIG. 1b shows, in a three-dimensional space, another embodiment of the quantum radar system based on NV-centers according to the invention with multiple range bins, each built around two FET corner front-gates and a NV-based nanostructure placed within their inter-space along a Drain-Source channel, and having such corner gates connected to d e antenna via filters, amplifiers and optional mixer; FIG. 1c illustrates, in a three-dimensional space, another embodiment of the quantum radar system based on NV-centers according to the invention with multiple range bins, each built through a FET corner front-gate and back-gate facing a NV-based nanostructure along a Drain-Source channel, and having such corner gates connected to different antenna elements via separate filters, amplifiers and optional mixers.

### DETAILED DESCRIPTION OF THE INVENTION

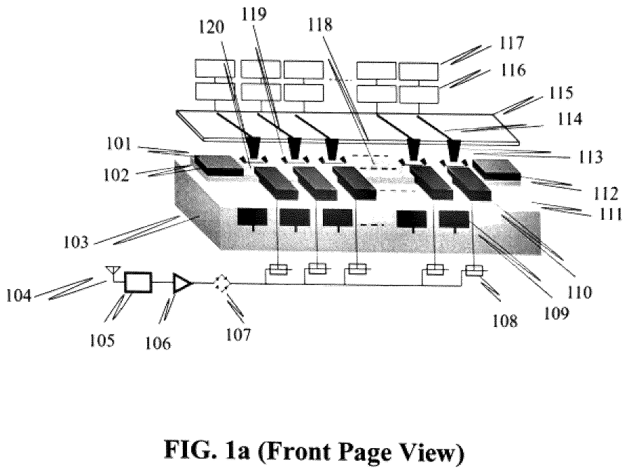

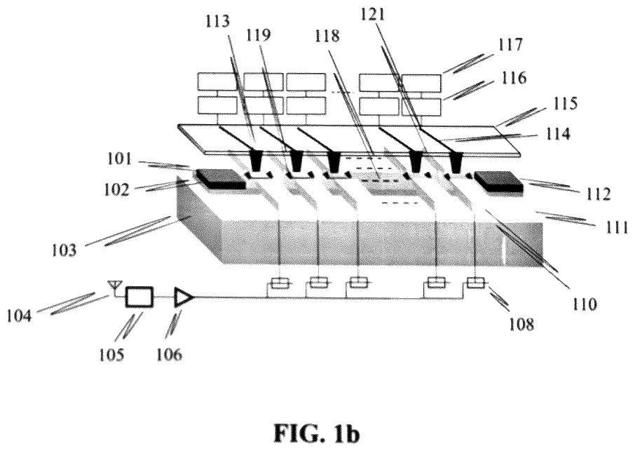

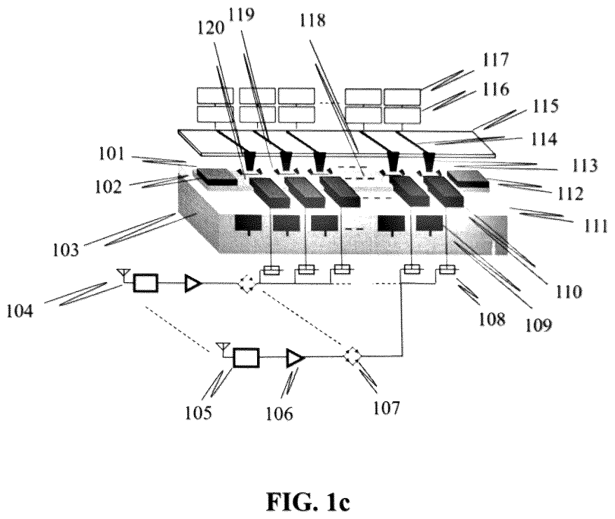

Referring to those drawings and more specifically to FIG. 1a, each range bin, in a preferred embodiment of the present invention, is built around a single FET (Field Effect Transistor) on silicon (102) over insulator (111) over silicon (103) placed across a drain (101)-source (112) channel (118), with a Field-Generation (FG) corner front-gate (110) and a Back-Gate (109), facing a NV-based nanostructure (113) for the measurement of time-windowed electromagnetic fields.

The target-reflected electromagnetic signal first gets received through an antenna (104) before being filtered (105) and amplified (106). The magnitude of the electrical field then gets extracted via a rectifier (107) before being sequentially applied to the Field-Generation corner front-gate (110) of each range bin over a fixed time duration. Each range bin getting sequentially activated via one input of the bias tree pin (108).

The electrical field, generated between the corner front-(110) and back-gate (109) of a given range bin, then reacts with the underlying quantum dot (120) velocity to produce a magnetic field polarized in the e.g. Y direction via Lorentz effect. The facing NV-based nanostructure (113), with quantization axis in the same e.g. Y direction, Implemented on an optical layer (115) and attached to an optical waveguide (114), finally computes the magnetic field value (of a given range bin) by measuring (117) the frequency delta between the two fluorescence peaks of an Optically-Detected Magnetic Resonance (ODMR) spectrum (116). The latter is obtained by recording the fluorescence of the corresponding NV center (113) as a function of the applied microwave frequency from the radiating element (119) of each range bin.

In another preferred embodiment of the present invention shown in FIG. 1b, each range bin is instead built around two FET (Field Effect Transistor) on silicon (102) over insulator (111) over silicon (103), placed across a drain (101)-source (112) channel (118), with corner gates (110, 121) facing one another.

The electrical field of the target-reflected electro-magnetic signal, after being received on the antenna (104), filtered (105) and amplified (106), is here sequentially applied horizontally between the corner front-gates (110, 121) of a given range bin (so polarized in the e.g. Y direction) over a fixed time duration. Each range bin getting sequentially activated via one input of the bias tree pin (108).

The NV-based nanostructure (113), with quantization axis in the perpendicular (e.g. Z direction), implemented on an optical layer (115) and attached to an optical waveguide (114), is placed within the inter-space of the two-corner front-gates (110, 121) of a given range bin, in order to directly compute, through the Stark effect, the electric field value (of a given range bin) by measuring (117) the frequency shift of the fluorescence peak of an Optically-Detected Magnetic Resonance (ODMR) spectrum (116). The latter is obtained by recording the fluorescence of the corresponding NV center as a function of the applied microwave frequency from the radiating element (119) of each range bin.

The two above approaches, shown in FIG. 1a and FIG. 1b, can further be scaled over multiple range bins and antennas by for instance implementing a series of gates in parallel along the Drain (102)-Source (112) channel (118). In the embodiment of the present invention shown in FIG. 1c, a series of corner gates (110) is connected to different antenna (104) elements via filters (105), amplifiers (106) and rectifiers (107). Such configuration allowing then the calculation of distance with very fine resolution over fast time, of speed through Doppler phase changes over slow time, and of azimuthal/elevation arrival angle through antenna phase shift and spatial frequency. This then leads to a complete 4-Dimension target detection with high precision.

As such, numerous modifications and variations of the present invention are possible in light of the above teachings. It is therefore to be understood that within the scope of the appended claims, the invention may be practiced otherwise than as specifically described herein.

1. A quantum radar system of which each range bin is built around a field-effect transistor on silicon over insulator with a corner front-gate, underlying quantum dot and back-gate facing a nitrogen-vacancy-based nanostructure.

2. A quantum radar system of which each range bin is built around two field-effect transistors on silicon over insulator with corner front-gates facing one another and a nitrogen-vacancy-based nanostructure placed within their inter space.

3. A quantum radar, as recited in claim 1, where the range bins are all connected to an antenna, via a filter and an amplifier, to compute both targets range and speed calculation.

4. A quantum radar, as recited in claim 2, where the range bins are all connected to an antenna, via a filter and an amplifier, to compute both targets range and speed calculation.

3. A quantum radar system, as recited in claim 1, where the range bins are connected to different set of antenna elements and amplifiers and filters, to further retrieve azimuthal and elevation angle of arrival of radar-echoes trough spatial phase shifting.

6. A quantum radar system, as recited in claim 2, where the range bins are connected to different set of antenna elements and amplifiers and filters, to further retrieve azimuthal and elevation angle of arrival of radar-echoes trough spatial phase shifting.
